(19) United States
(12) Patent Application Publication
(10) Pub. No.: US 2026/0319270 A1
(43) Pub. Date: Oct. 15, 2026

(54) ADAPTIVE CONTACT LENS DEVICE FOR MYOPIA CONTROL

(71) Applicant: Verily Life Sciences LLC, Dallas, TX (US)

(72) Inventors: Maxim Armstrong, South San Francisco, CA (US); Christian Gutierrez, South San Francisco, CA (US); Supriyo Sinha, South San Francisco, CA (US); Leslie Small, South San Francisco, CA (US); Alexandre Tumlinson, South San Francisco, CA (US)

(21) Appl. No.: 19/481,398

(22) PCT Filed: May 3, 2024
(86) PCT No.: PCT/US2024/027817

§ 371 Date: Nov. 4, 2025

Related U.S. Application Data
(60) Provisional application No. 63/464,275, filed on May 5, 2023.

(51) Int. Cl. G02C 7/04; G02C 7/08; G02C 7/12

(52) U.S. Cl. CPC G02C 7/04; G02C 7/083; G02C 7/12; G02C 2202/24

(57) ABSTRACT

A lens device that can be placed on a patient's eye for treating and/or preventing myopia. The lens device includes a body comprising a gas-permeable material that can at least partially encompass one or more adaptive optical elements and an electrical circuit and/or actuator. The adaptive optical elements can switch between an optical state and at least another state when the electrical circuit and/or actuator cases the switch based on a control signal. The adaptive optical elements switch between the optical state at a time and the at least the other optical state at another time for a time period to present visual stimuli to a peripheral retina to slow axial growth of the eye in order to treat and/or prevent myopia.

### RELATED APPLICATION

The present application is a national phase application of Patent Cooperation Treaty (PCT) Application No. PCT/US2024/027817, filed on 3 May 2024, which claims priority to U.S. Provisional Application Ser. No. 63/464,275, filed 5 May 2023, entitled “ADAPTIVE OPHTHALMIC DEVICE FOR MYOPIA CONTROL,” the entirety of which are hereby incorporated by reference for all purposes.

### TECHNICAL FIELD

The present disclosure relates to myopia control, and, more specifically, to systems and methods for controlling and preventing progression of myopia and/or treating myopia by adaptively changing the optical states of a lens device having one or more adaptive optical elements to present different visual stimuli to a peripheral retina at a given time to slow axial growth.

### BACKGROUND

Myopia, or nearsightedness, commonly develops during childhood but may manifest as a person ages. The prevalence of myopia is increasing worldwide at a rapid pace. The increasing prevalence of myopia may be due to an increase in near-work, including mobile phone or computer screen use. With myopia, a person can see close objects clearly but struggles to see objects that are farther away. Generally, to focus on near objects (such as mobile phones and computer screens), the eye accommodates by changing the shape of the intraocular lens to produce a focused image at the fovea. In accommodated eyes, or eyes with corrective lenses, the focused image shell does not lie directly on the retina over its entire area, especially at the periphery. This unfocused image likely provides a signal for the eye to elongate, worsening myopia. Patients suffering from myopia are most commonly treated with single vision corrective lenses, which place a large area on the retina in hyperopic focus, prompting elongation. The corrective lenses merely correct some of the effects of myopia and do not control its progression, leaving the patient at risk for a number of vision-threatening disorders, including worsening myopia, glaucoma, retinal detachment, macular degeneration, and the like, that have been correlated to myopia.

### SUMMARY

Described herein are systems and methods for controlling and slowing the progression of myopia by changing the optical state of a lens device having one or more adaptive optical elements. The optical states can be changed by altering the state of one or more adaptive optical elements within the ophthalmic device to present different visual stimuli to a peripheral retina to slow axial growth of the eye.

In one aspect, the present disclosure includes a lens device configured to be placed on a patient's eye for treating and/or preventing myopia, the lens device comprises: a body comprising a gas-permeable material; one or more adaptive optical elements embedded in the gas-permeable material and each of the one or more adaptive optical elements configured to switch between an optical state and at least another optical state; and an electrical circuit and/or actuator configured to cause one or more adaptive optical elements to switch between the optical state and the at least the other optical state based on a control signal, wherein the one or more adaptive optical elements switch between the optical state at a time and the at least the other optical state at another time for a time period to present visual stimuli to a peripheral retina to slow axial growth of the eye.

In another aspect, the present disclosure includes a system for treating and/or preventing myopia, the system comprising: a lens device configured to be placed on a patient's eye for treating and/or preventing myopia, the lens device comprises: a body comprising a gas-permeable material; one or more adaptive optical elements embedded in the gas-permeable material and each of one or more adaptive optical elements configured to switch between an optical state and at least another optical state; and an electrical circuit and/or actuator configured to cause one or more adaptive optical elements to switch between the optical state and the at least the other optical state based on a control signal, wherein the one or more of the plurality of adaptive optical elements switch between the optical state at a time and the at least the other optical state at another time for a time period to present visual stimuli to a peripheral retina to slow axial growth of the eye, an external source configured to deliver an input signal to an electrical circuit and/or the actuator, wherein the external source comprises: at least one sensor detecting a condition of the eye, and/or an external mobile device receiving a manual input from the patient and/or a medical professional.

In a further aspect, the present disclosure includes a method for treating and/or preventing myopia, the method comprising: receiving, by a processor associated with a lens device configured to be worn on a patient's eye, a signal to adjust one or more adaptive optical elements of the lens device, wherein the lens device comprises: a body comprising a gas-permeable material, one or more adaptive optical elements embedded in the gas-permeable material and each of the one or more adaptive optical elements configured to switch between an optical state and at least another optical state, and an electrical circuit and/or actuator configured to cause one or more adaptive optical elements to switch between the optical state and the at least the other optical state based on a control signal; adjusting, by the processor, the control signal to cause the one or more adaptive optical elements to change a corrective power of at least a portion of the lens device; and sending, by the processor, the adjusted control signal to the electrical circuit and/or actuator to cause the one or more of the plurality of the adaptive optical elements to switch between the optical state at a time and the at least the other optical state at another time for a time period to present visual stimuli to a peripheral retina to slow axial growth of the eye.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a prior art illustration of a location of an image shell for uncorrected myopia, traditional correction of myopia, and optimal correction of myopia;

FIG. 2 is a diagram of an ophthalmic device that can be used to control and slow the progression of myopia;

FIG. 3 includes illustrations of example zones of adaptive optical elements in the ophthalmic device of FIG. 2;

FIG. 4 is an illustration of an example of the ophthalmic device of FIG. 2 in use;

FIGS. 5-6 are zoomed in cut-view diagrams at A-A of the example ophthalmic device of FIG. 4;

FIG. 7-9 are diagrams showing example systems that can be used to control and slow the progression of myopia using the ophthalmic device of FIG. 2;

FIG. 10 is an example illustration of a control loop operation using the system of FIG. 9;

FIG. 11 is an illustration of an example ophthalmic device of FIG. 2;

FIG. 12 is an illustration and graphical representation of the change in corrective power at two different optical states across the radius of the ophthalmic device of FIG. 2;

FIG. 13 is an illustration of different focus lengths at two different optical states of the ophthalmic device of FIG. 2;

FIG. 14 is an illustration and graphical representation of a variable power profile of the ophthalmic device of FIG. 2;

FIG. 15 shows graphical representations of a user controlled optical state switch;

FIG. 16 is a graphical representation of scheduled optical state switches;

FIG. 17 is an illustration of an example system that includes the ophthalmic device of FIG. 2 and a wearable device; and

FIG. 18 is a process flow diagram of an example method for controlling and slowing the progression of myopia by changing the corrective power of an ophthalmic device having one or more adaptive optical elements.

### DETAILED DESCRIPTION

### 1. Definitions

Unless otherwise defined, all technical terms used herein have the same meaning as commonly understood by one of ordinary skill in the art to which the present disclosure pertains.

As used herein, the singular forms “a,” “an,” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “ophthalmic device” refers to a medical instrument used on or within at least a portion of a patient's eye for optometry or ophthalmology purposes (e.g., for diagnosis, surgery, vision correction, disorder treatment, or the like). An example of an ophthalmic device can include a contact lens, otherwise called a “lens device” herein. An ophthalmic device can be “smart” when it includes one or more components that facilitate one or more active processes for purposes other than traditional passive lens-based vision correction (e.g., therapeutic agent release, modulation of light transmission, adjustment of corrective power, or the like). Unless otherwise stated, as used herein, the term “ophthalmic device” should be understood to mean “smart ophthalmic device” and to refer to a contact lens type ophthalmic device. Smart can refer to a device with at least one processing capability and/or electronically connected component.

As used herein, the term “myopia”, also referred to as “nearsightedness” via elongation, can refer to a common vision condition in which objects that are near are seen clearly, but objects farther away are blurry.

As used herein, the term “adaptive” refers to something that is able to change.

As used herein, the terms “adaptive element”, “adaptive optical element”, or the like refers to any material or combination of materials that undergoes a change in light transmissibility and/or focus in response to a signal (e.g., an electrical signal). Non-limiting examples of adaptive optical elements include, but are not limited to electrochromic materials, liquid crystal materials, pH sensitive materials, a boundary between two immiscible fluid elements with different refractive indices, and thermodynamic materials.

As used herein, the term “electrical signal” refers to a signal waveform generated by an electronic means, such as a signal generator. An electrical signal may be a voltage signal or a current signal. An electrical signal can have variable parameters including, but not limited to, frequency, magnitude, shape, amplitude, and polarity. The variable parameters can be controlled, for example, by a controller in communication with the signal generator. The electrical signal can be generated in response to a signal from another source and can act as an actuating signal.

As used herein, the term “actuator” refers to a component responsible for controlling activity of a mechanism or system (e.g., one or more adaptive optical elements). An actuator includes at least a control device (controlled by receiving a signal and outputting another signal or form of energy) and a source of energy (or is connected to an energy source). Examples of actuators can include an electronic circuit, a mechanical means, a hydraulic means, a pneumatic means, and/or a magnetic means. In some instances, the terms actuator and electric circuit may be used interchangeably (e.g., an actuator and/or an electronic circuit).

As used herein, the term “embedded” refers to something that is fixed firmly and deeply into a surrounding material. An object that is embedded in a material may be encapsulated within the material.

As used herein, the term “encapsulate” refers to fully enclosing an object (e.g., one or more adaptive optical elements) within something else (e.g., a body of an ophthalmic device).

As used herein, the terms “patient”, “subject”, “user”, “wearer”, and the like can be used interchangeably and can refer to an animal (e.g., a human) suffering from or at risk of suffering from myopia and/or a condition associated with myopia.

### II. Overview

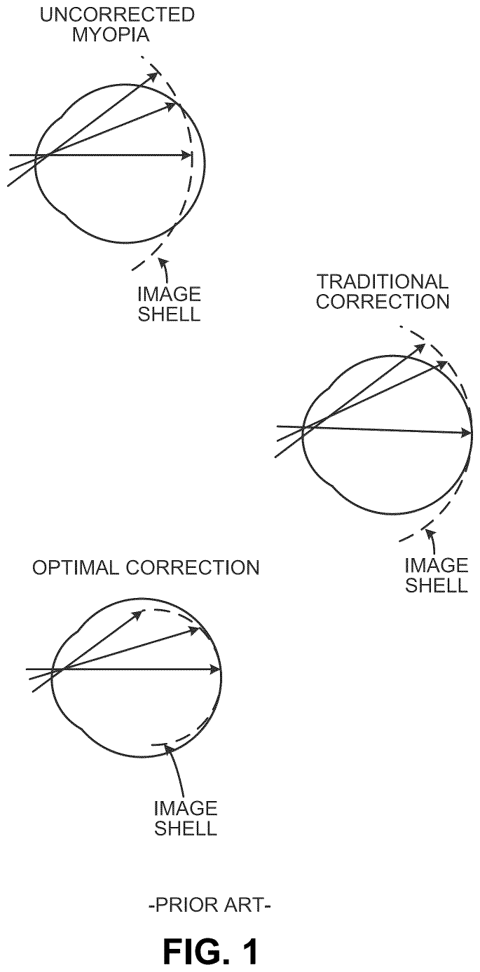

Myopia, or nearsightedness, is increasing worldwide at a rapid pace. In uncorrected myopia an image shell can be incorrectly positioned relative to both a central and a peripheral retina of the eye such that a person's vision is blurred (see FIG. 1). Several solutions for treating the effects of myopia and/or preventing the progression of myopia have been proposed, including simple solutions that treat the symptoms of myopia (like corrective lenses), solutions that try to prevent myopia (e.g., variable power lenses, multifocal lenses, lenses with brief periods of positive correction, etc.), and pharmacological or light-based treatment solutions. Some solutions have shown promise in preventing myopia or treating the effects but are expensive, time-intensive, or have a serious risk of infection or other unpleasant/unsafe side effects. Traditional correction of myopia, as shown in prior art FIG. 1, can correct the image shell such that the central view of a user is “fixed” by placing a large central area of the retina in corrected focus, however failing to provide a growth stopping signal for retinal elongation as the peripheral zones are left uncorrected. Optimal correction would include properly focusing the imaging shell for both central and peripheral vision (e.g., correction is applied to both the central and peripheral retina.

The progression of myopia can be prevented, and the effects of myopia can be controlled in an improved, less expensive, and safe manner with the ophthalmic device described herein. Described herein are systems and methods for controlling or slowing the progression of myopia using an actuator to initiate alterations to one or more adaptive optical elements within an ophthalmic device (referred to interchangeably as a contact lens, a lens device, or the like) to present different visual stimuli to the retina by changing the corrective power, focus length and/or depth, and/or focal plane and image plane associated with at least a portion of the ophthalmic device at a given time to slow axial growth of the eye. It should be understood that the extreme field of view, significant optical aberrations, and approximately spherical nature of the posterior eyeball highlight that what are described herein as planes can equivalently and/or more generally be referred to as surfaces or shells with similar optical definitions, which may be defined in a limit as locally planar.

The ophthalmic device can include a body and adaptive optical elements embedded in the body designed to mitigate the development and/or progression of myopia and/or control symptoms of myopia. Any adaptation and/or adjustment of the adaptive optical elements can be controlled by an actuator (in conjunction with a controller). The adaptation and/or adjustment of the adaptive optical elements can change the corrective power profile of at least a portion of the ophthalmic device to dynamically adjust the focal length and/or image/focal plane with respect to the retina continuously and/or at one or more discrete times to produce a therapeutic refractive state in the eye without the expense, time required, risk of infection, or potential for side effects of previous solutions. Importantly the adaptive nature of the lens device described herein is a significant improvement over the current static multifocal lenses on the market. For instance, choosing the timing and duration at which optical states are changed can significantly reduce negative effects such as headaches, nausea, eye strain, and/or compromised vision. Moreover, wider corrective power fluctuations between optical states are possible (e.g., from 1 to 2 diopters difference, up to 3 or 4 or more diopters difference) without causing ill effect to a user because the durations of therapy can be short (e.g., between a few minutes and a few hours a day) and the rest of the time the user's central vision can be normally corrected.

### III. System

Myopia, also referred to as nearsightedness via elongation, is a common vision condition whose prevalence is increasing worldwide at a rapid pace. With myopia objects that are near are seen clearly, but objects farther away are blurry.

Traditional ways to correct myopia leave a large area on the retina in hyperoptic focus, prompting continued elongation. As described herein, the progression of myopia can be controlled (e.g., slowed) by employing an ophthalmic device that can be designed to dynamically change optical states of at least a portion of the ophthalmic device to mitigate the development and/or progression of myopia. The ophthalmic device can include one or more adaptive optical elements that can be used to change the optical state (e.g., by varying the optical power or focus, or the like) of the ophthalmic device to dynamically adjust the focal length and/or image/focal plane with respect to the retina continuously or at discrete times to produce a therapeutic refractive state in the eye. Simply, the therapeutic state(s) can provide visual stimuli to the eye to stop (or slow) axial and/or improper growth within the eye as a result of myopia and/or traditional myopia correction methods.

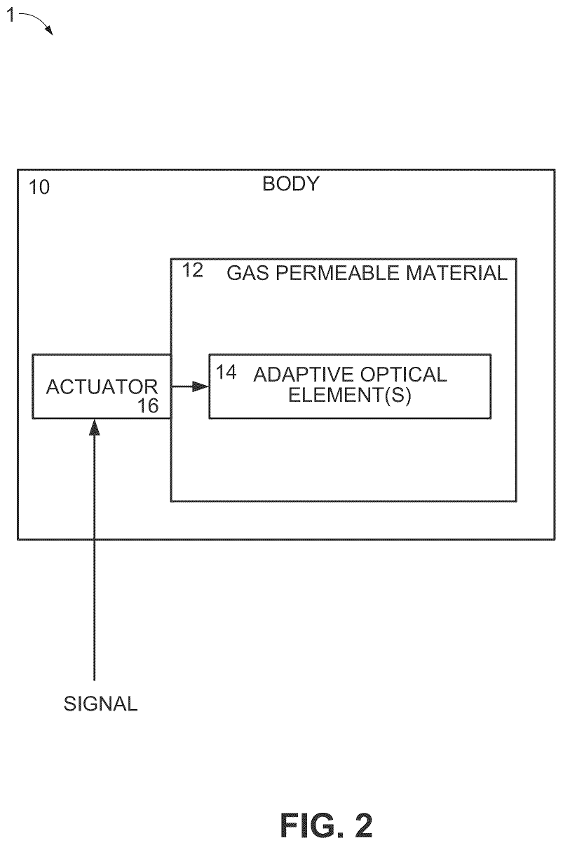

FIG. 2 is a diagram of an ophthalmic device 1 (referred to interchangeably as a contact lens a lens device, or the like) configured to be designed to mitigate the development and/or progression of myopia. As noted, the ophthalmic device 1 can include one or more one or more adaptive optical elements 14 that can change configurations to provide therapy to the eye. The ophthalmic device 1 can include a body 10 that can include and/or be composed at least partially of a gas permeable material 12. The ophthalmic device 1 can also include one or more adaptive optical elements 14 within the gas permeable material 12 and an actuator 16 (which can be an electrical circuit and/or actuator) (at least a portion of which contacts the one or more adaptive optical elements 14). The ophthalmic device 1 may also include additional hardware embedded therein that is not illustrated, like a substrate, a power source such as a battery and/or a wireless/inductive power source, a processor, a memory, one or more wireless communications devices configured for one or more wireless communication protocols, one or more controllers, sensor(s), actuator(s), electronics modules, logic modules, or the like. Notably, the ophthalmic device 1 can be positioned on and removed from the eye by a user at will. In some instances, the positioning and removal can be accomplished without the assistance of a trained healthcare professional. As an example, the ophthalmic device 1 can be a contact lens.

The body 10 can be substantially made of a biocompatible material suitable/safe for optical wear that is hard and substantially inflexible or is soft and flexible. Similarly, the gas permeable material 12 can also be substantially made of a same or different biocompatible material suitable/safe for optical wear that is hard and substantially inflexible or is soft and flexible. In some instances (as illustrated), the gas permeable material 12 can be within at least a portion of the body 10 (different biocompatible materials suitable/safe for optical wear). In some instances, the ophthalmic device 1 can include a fixed corrective power portion and a variable corrective power portion. In other instances, the ophthalmic device 1 can include multiple variable corrective power portions embedded in various positions throughout the body 10 (e.g., in radial rings, central vs peripheral, left vs right sides of the device, or the like). In other instances, the gas permeable material 12 can make up the entire body 10 (such that body 10 and gas permeable material 12 are equivalent with the same biocompatible materials suitable/safe for optical wear with the adaptive optical element(s) 10 and the actuator 16 both embedded within the gas permeable material). Examples of such biocompatible materials that are suitable/safe for optical wear include polymethyl methacrylate (PMMA), polyhydroxyethylmethacrylate (polyHEMA), polyethylene glycol, silicone hydrogel, silicon-based polymer(s) like fluoro-silicon acrylate, silicone elastomer, combinations thereof, or the like.

The one or more adaptive optical elements 14 can be embedded within the gas permeable material 12 and can switch between at least one optical state and at least another optical state in at least a portion of the ophthalmic device 1 to present different visual stimulus to at least the peripheral retina to slow axial growth of the eye. The optical states can be changed according to a time, a signal from a user, a signal from a sensor (not shown), or the like. The adaptive optical element(s) 14 can include, but are not limited to, electrochromic materials, liquid crystal materials, pH sensitive materials, a boundary between two immiscible fluid elements with different refractive indices, or thermodynamic materials. In some instances, the adaptive optical element(s) 14 can be encased in or include another material that is generally not adaptive. The adaptive optical element(s) 14 can be layered and/or positioned at discrete location within the body 10 of the ophthalmic device 1 to best effect the vision of the user. Examples of the adaptive optical elements 14 are described in more detail below.

The actuator 16 can be responsible for controlling activity of the one or more adaptive optical elements 14 by initiating a change in the one or more adaptive optical elements that cause a switch between the at least the first optical state and the at least the other optical state based on a control signal received by the actuator. As noted, at least a portion of the actuator 16 can contact the adaptive optical elements 14. Accordingly, at least the portion of the actuator 16 can be within the gas permeable material 12 in some instances. In other instances, the entire actuator 16 can be within the gas permeable material 12. The actuator 16 can include at least a control device (controlled by receiving a signal and outputting another signal or form of energy) and a source of energy (or is connected to an energy source). For example, the actuator 16 can include an electronic circuit, a mechanical means, a hydraulic means, a pneumatic means, a magnetic means, or the like. The method by which the actuator 16 can control the activity of the one or more adaptive optical elements 14 can be based on the type of actuator and type(s) of adaptive optical element(s) implemented.

The actuator 16 can receive a signal (also referred to as an input signal or a control signal) that can be indicative of an instruction to activate and/or reconfigure the adaptive optical elements 14. As an example, the signal may be based on information from a source (e.g., a sensor, a memory, etc.) within the ophthalmic device 1. In another example, as illustrated, the signal may be based on information from an external source (e.g., a sensor, a mobile device, etc.). As a further example, the signal may be based on information from a source within the ophthalmic device 1 and from an external source. For example, when the actuator 16 is an electronic circuit, a voltage (e.g., greater than a threshold or predetermined value) can be generated to make the adaptive optical element(s) 14 change configuration to change a corrective power.

The signal can be generated based on the following conditions (while corrective power will be described, it will be understood that focus length and/or plane, or any other traditional optical correction can also be modulated). In some instances, the ophthalmic device 1 can use an approximately uniform power change when powered (power on at one power and power off at approximately 0). For example, an approximately uniform power can be added across the ophthalmic device 1. Brief periods of positive correction (e.g., minutes, hours, days, etc.) can prevent myopia development. Positive correction therapy sessions can be timed to be as unobtrusive as possible to daily activities. In other instances, the ophthalmic device 1 can use tailored on/off profiles for myopia therapy. As an example, the corrective power change across the ophthalmic device 1 can be non-uniform. With some constraints, two distinct corrective power profiles (a positive value and a negative value) can be chosen within a certain range for a patient. Either profile can be selected at will (manually or automatically), depending on the task at hand. In further instances, the ophthalmic device 1 can include integrated sensing of the eye's state (e.g., accommodation, gaze, pupil dilation, etc.) and/or external sensors (e.g., EMG sensors, optical sensors, and the like) to determine the ideal corrective power state. In this case, the ophthalmic device can automatically respond to accommodation (e.g., a near optimized and a distance optimized accommodation).

As an example, the adaptive optical elements 14 can switch between an optical state at a time and at least another optical state at another time to present visual stimuli to a peripheral retina to slow axial growth of the eye. The visual stimuli can be presented in such a manner that side effects such as headaches, blurriness, eye strain, and the like are minimized for a user. For example, the visual stimuli that is different from a user's traditional prescription can be presented when the user is not focusing the eye (e.g., in the evening, when triggered by a sensor or manual user input, or the like). For instances, the visual stimuli can include a transformation of a visual scene, where the transformation preserves at least 10% contrast at a spatial frequency of at least 1 cycle/degree. The optical state can have a corrective power and an associated focal plane and/or length and the at least the other optical state (for as many other optical states as can be triggered) can have another corrective power and associated focal plane and/or length. In one instance, the optical state can have a corrective power to focus the visual stimuli relative to the peripheral retina and the at least the other optical state can have a greater corrective power to focus the visual stimuli at a shorter distance relative to the peripheral retina.

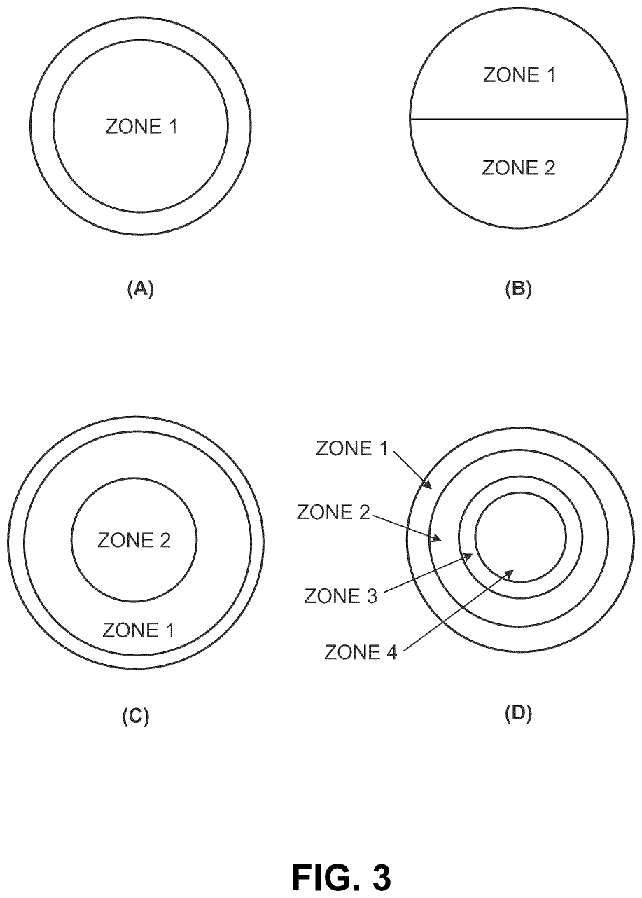

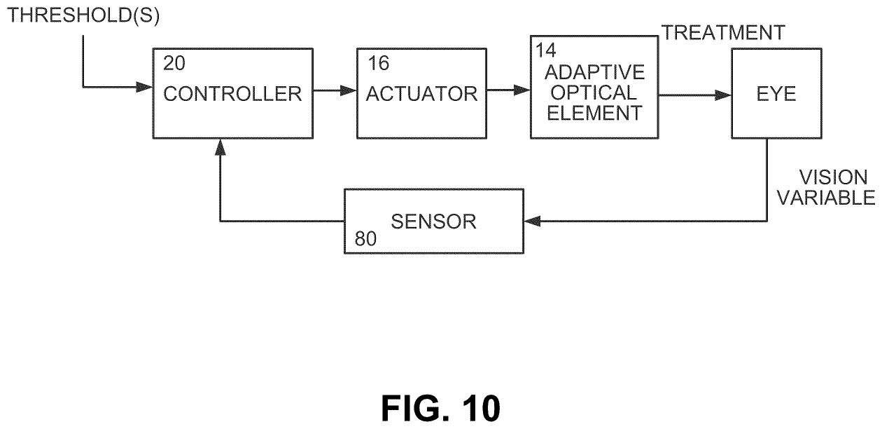

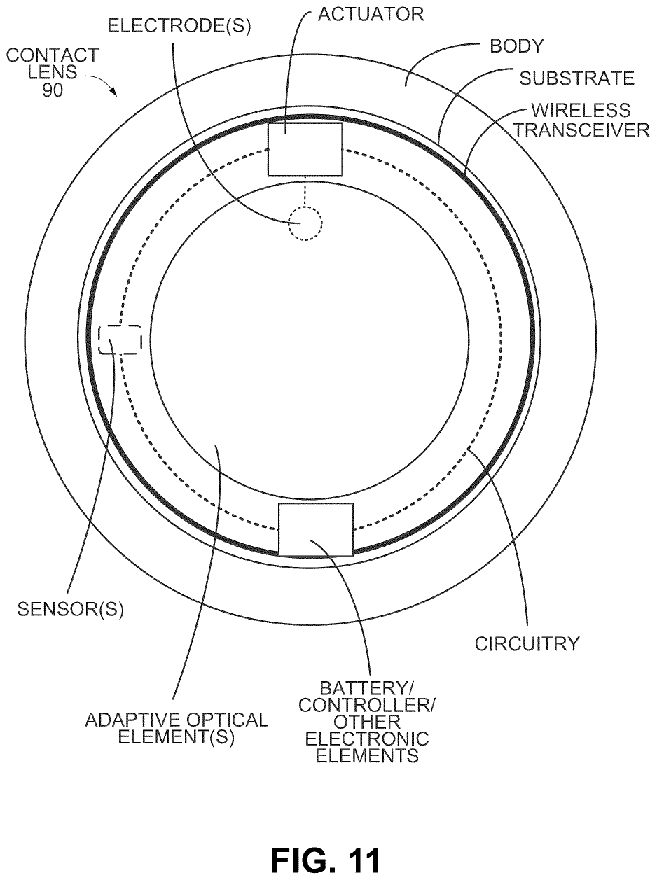

As shown in FIG. 3 (elements A, B, C, and D), the adaptive optical elements 14 can be configured in one or more zones that can affect the vision of the user in different manners depending on the optical state of each of the zones at a given time. It should be understood that these examples are for illustrative purpose only and should not be considered limiting. Any other configurations and/or numbers of zones one or greater can be considered based on these examples. FIG. 3, element A, shows an example where the one or more adaptive optical elements are in a single zone (Zone 1) and can change optical states across an entire viewable portion of a body of the ophthalmic device. For instance, the single zone can provide an approximately uniform power across the zone in the optical state (power off) and an approximately uniform power add across the zone in the other optical state (e.g., power on) as shown in the graph of FIG. 12. The positive correction therapy can be applied for brief periods of time (e.g., minutes/day) and can be timed to be unobtrusive (as the user's vision will alter with the change in corrective power). For instance, shown in the eye diagram of FIG. 12, when the other optical state is active the focal plane can be “deeper” into the eye than when the optical state is active. In another instance, as shown in the illustration of the eye in FIG. 13, the optical states can be changed when a patient's focus changes (e.g., focused at a distance or close by) and/or the different optical states can change the focus of the eye, for example from 10 m focus to 30 cm focus or vice versa,

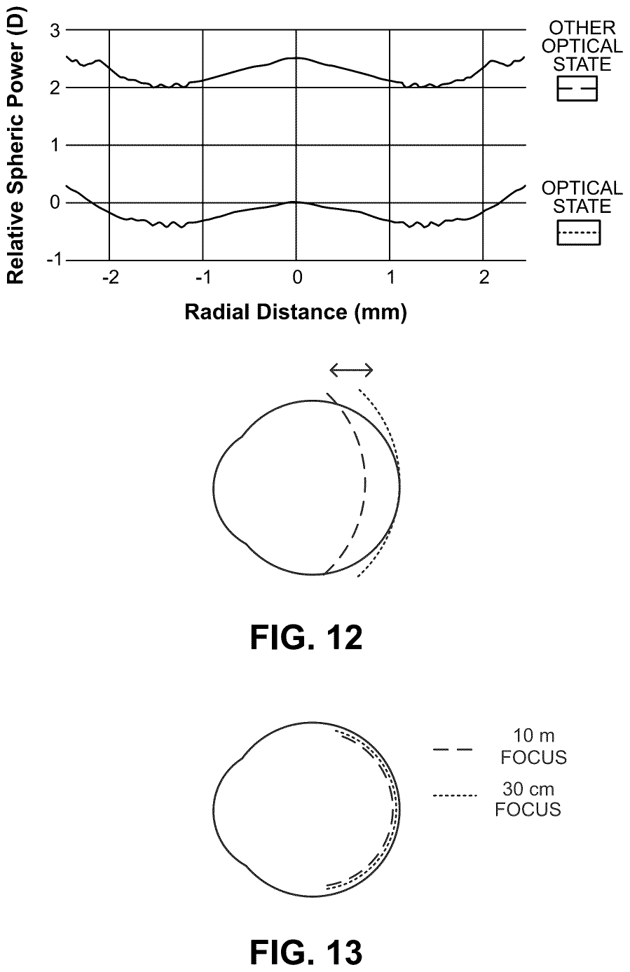

FIG. 3, elements B and C, show examples with two optical zones (Zone 1 and Zone 2) where the one or more adaptive optical elements are positioned within different portions of the body of the lens device. For example, side by side (which can be vertical or horizonal) or radially (e.g., central zone 2 and more peripheral zone 1). FIG. 3, element D, shows an example with four zones each positioned at a different radial length from the center of a lens. The optical state of the at least two zones of the one or more adaptive optical elements can have a same corrective power and an associated focal plane and/or length and in the at least the other optical state the at least two zones can have different corrective powers and associated focal lengths and/or planes than the optical state. Each of the at least two zones can have the same and/or different corrective powers and associated focal lengths and/or planes per optical state. As shown in FIG. 3, element C, a central zone and a peripheral zone are shown. The central zone and the peripheral zone in the optical state can have a same corrective power and an associated focal length and/or focal plane. The central zone and the peripheral zone in the at least the other optical state can each have a different corrective power and the associated focal lengths and/or focal planes (than in the optical state, which can be the same and or different from each other). The use of more than one zone can allow for a variable power profile (e.g., a non-uniform power change) across the body of the lens device. As shown in FIG. 14, the power profile can be anywhere between about 4 and about −2 at any radial distance from the center of the lens depending on the optical states selected for each of the zones. Two or more distinct power profiles can be chosen within these ranges.

In some instances, regardless of the number of zones, the one or more adaptive optical elements, in the optical state and/or the other optical state, can each affect the light of different incident polarization independently. When one adaptive optical element changes from an optical state (the first optical state) to another optical state (the second optical state) this change can affect only the light of one polarization (e.g., vertical linear polarization, right-handed circular polarization, or the like) while leaving the orthogonal incident polarization (e.g., horizontal linear polarization, left-handed circular polarization, or the like) unchanged. For instance, one adaptive optical element can affect one polarization of an incident light, wherein the optical state has a corrective power that is common for all polarizations of the incident light and the at least the other optical state can have another corrective power that is different between orthogonal polarizations of the incident light.

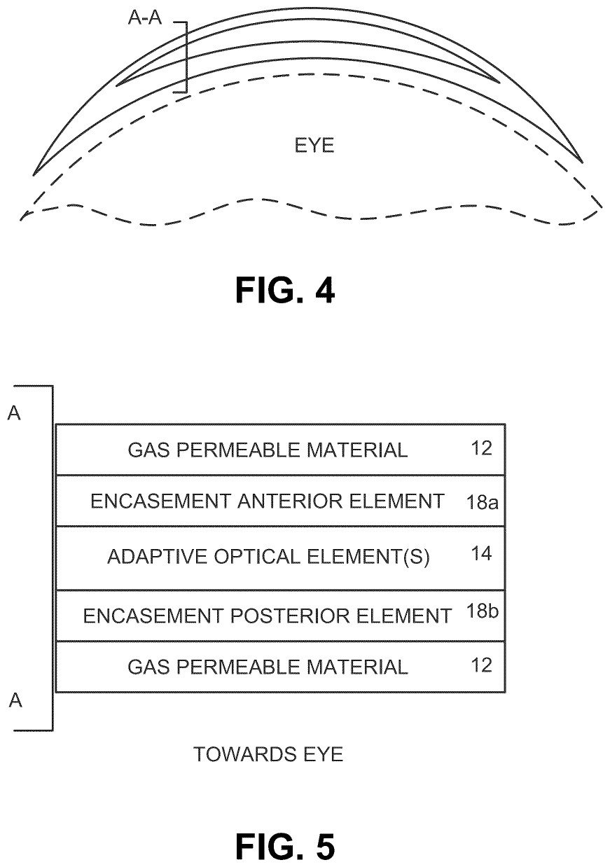

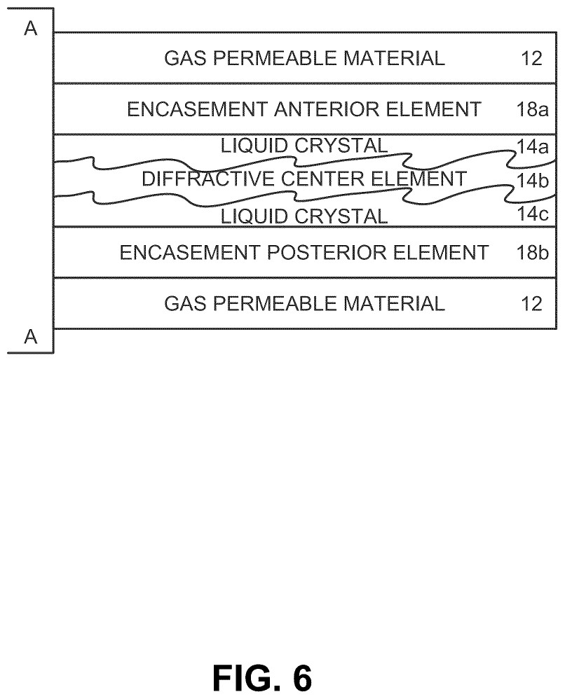

An illustration of an example of the ophthalmic device (like that of FIG. 2) in use is shown in FIG. 4. In this example, the ophthalmic device can be mounted on the outside of the globe of the eye and at least partially under the eyelids (not shown) (e.g., similar to a traditional contact lens). This example only shows a portion of FIG. 2 for ease of explanation. Different configurations of a zoomed in portion of the ophthalmic device at cut line A-A are shown in FIGS. 5 and 6 (however, these examples are not intended to be limiting). The ophthalmic device generally is inactive in a state of the adaptive optical elements and active in another state of the adaptive optical elements. The ophthalmic device can also have multiple active states with different corrective powers and/or different combinations of corrective powers at different portions of the device. By implementing a switching between states, the ophthalmic device can deliver a larger multifocal range that a user, even a child, can tolerate under all conditions.

As shown in FIG. 4, the ophthalmic device at cut line A-A can include a stack of different materials, including the gas permeable material 12 at the top and bottom of the stack (anterior and posterior). Next to the gas permeable material 12 are anterior encasement element 18a and posterior encasement element 18b. The encasement elements 18a and 18b can surround the adaptive optical elements 14. However, the encasement elements 18a and 18b may not be strictly necessary. It should be noted, in some instances, that in order to provide a range of corrective powers, the adaptive optical elements 14 can include variable, refractive, and/or diffractive elements and can be different elements or actuated by different actuators at different portions of the ophthalmic device (e.g., the adaptive optical elements 14 can have a fixed corrective power at the fovea and a variable corrective power towards the periphery).

In some instances, the encasement elements 18a, b and/or the adaptive ocular elements 14 can be gas permeable and, in some instances, at least substantially oxygen permeable. In some instances, the adaptive ocular elements 14 can be active in a single polarization state, allowing the optical device to be constructed with fewer, possibly only one, active layers and therefore be cheaper to manufacture, thinner, more comfortable, and more gas permeable. In some instances, the adaptive ocular elements 14 can change power according to an ideal power profile for myopia (e.g., for near and distance work). In other instances, the adaptive ocular elements 14 can add power in the evening while the user is not reading, commuting, or performing delicate tasks possibly placing the central vision out of focus while focusing the periphery.

FIG. 5 shows a specific example where the adaptive ocular elements (shown as 14 in FIG. 4) can include liquid crystal layers 14 a and 14 c surrounding a diffractive center element 14b (referred to collectively as an electrically activated liquid crystal switchable diffractive lens). The liquid crystal layers 14a and 14c may be activated by a voltage change across the liquid crystals layers 14 that can change the refractive index, while the diffractive center 14b may contain elements that can add or subtract multiple diopters when powered. For example, an actuator (not illustrated) can be a circuit that can provide a voltage required to cause a change in confirmation of the liquid crystal elements to change the crystal state and, thus, the refractive state of the liquid crystal elements. A liquid crystal switchable diffractive lens may be active in only one polarization of incident light. In this active case, the liquid crystal switchable diffractive lens switches between a monofocal state where the user will have the best central vision, and a therapeutic multifocal state where the two orthogonal polarizations are focused at different planes in the eye. By implementing a switching between states, the ophthalmic device is able to deliver a larger multifocal range than a user would be happy to tolerate under all conditions. As another example that is not illustrated, the adaptive optical elements can include a boundary between two immiscible liquids with different refractive indices and the actuator can deliver a voltage over a threshold (or predetermined value) that dictates the fluid boundary curvature via electrowetting.

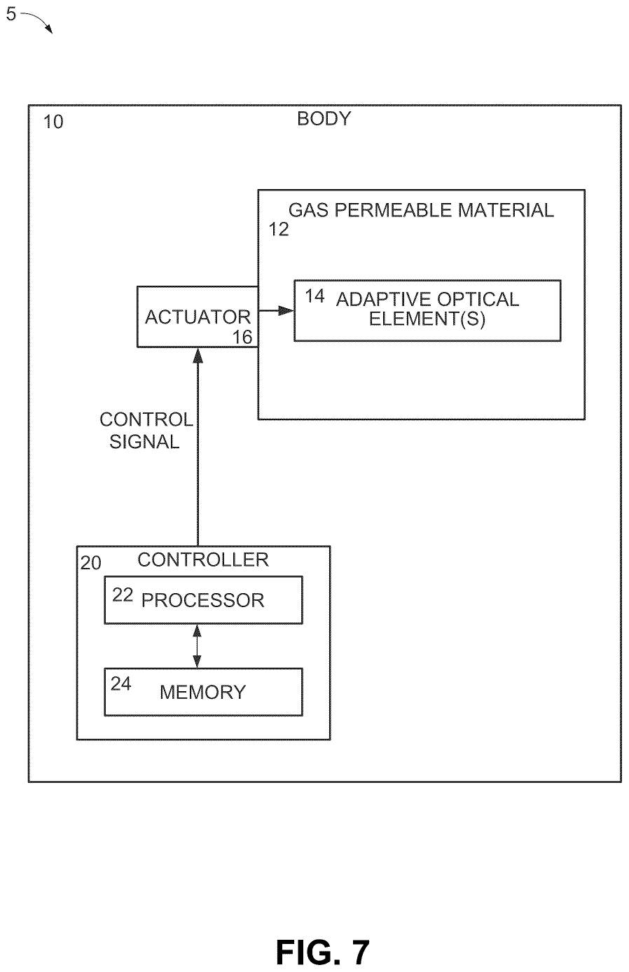

FIG. 7-9 are diagrams showing example systems 5, 6, and 7 that can be used to treat, prevent, and/or slow the progression of myopia using the ophthalmic device of FIG. 2. These example systems can utilize different algorithms and input mechanism for operation of the ophthalmic device. For example, the ophthalmic device can be operated in a user-controlled manner, using blinking or squinting to toggle power or manual input on a connected mobile device. As another example, the ophthalmic device can be operated in a pre-scheduled manner, in which aspects of the ophthalmic device can be controlled based on pre-set factors and/or scheduled treatment (e.g., achieving certain doses of added corrective power, minimizing interference with daily activities, based on circadian rhythm, etc.). The dose can be based on a pre-programmed duty cycle of active optics, aimed to deliver a certain dose of positive refractive power, targeting the most impactful times of the eye's circadian rhythm, or minimizing interference with daily activities. As a further example, the ophthalmic device can be operated in a closed loop manner based on a measured (internal or external) factor and/or with a goal of achieving a degree of natural accommodation.

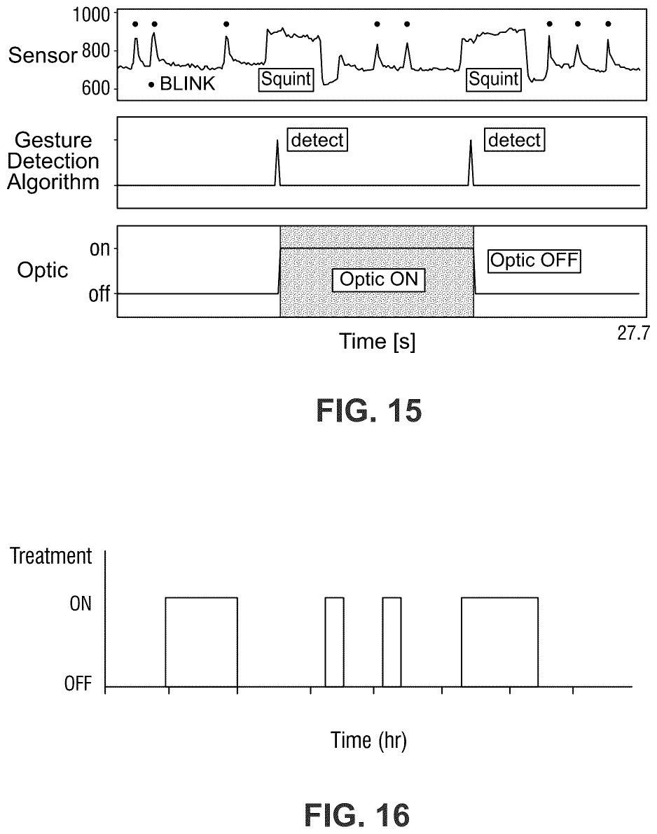

Referring now to FIG. 7, illustrated is a system 5 that includes a controller 20 within the body 10 of the ophthalmic device. The controller 20 can include a processor 22 and a non-transitory memory 24. In some instances, at least a portion of the controller 20 can be outside the ophthalmic device. The controller 20 can adjust the control signal sent to the actuator to adjust the one or more adaptive optical element(s) 14 based on an input from memory 24. The controller 20 can send a control signal to the actuator 20 related to activation of the actuator to trigger the adaptive optical elements 14. The control signal can be sent based on instructions stored in memory 24 and accessed by processor 22. For example, the instructions stored in the memory 24 can include a predetermined therapeutic schedule including predetermined corrective power(s), scheduled time (e.g., specific times of the day), timing (e.g., a number of times per day, per day, per week, etc. for any given number of corrective power adjustments), duration, and the like. FIG. 16 shows an example graphical representation of prescheduled treatments with various durations of treatment across a given time period of the day. For instance, off can refer to the one or more adaptive optical elements in a first or rest optical state and on can refer to the one or more adaptive optical elements being actuated into the other optical state to change the visual stimuli to change corrective power and the associated focal length and/or plane.

FIG. 8 shows a system 6 that includes a controller 20 within the body 10 of an ophthalmic device that can be in communication (e.g., wireless communication) with a mobile device 60. The controller 20 can include a processor 22 and a non-transitory memory 24. In some instances, at least a portion of the controller 20 can be outside the ophthalmic device body 10. The controller 20 can adjust the control signal sent to the actuator to adjust the one or more adaptive optical element(s) 14 based on an input from the mobile device 60. The input from the mobile device 60 can include a manual input to trigger a specified control signal and a specified configuration of the adaptive optical element(s) 14 for a specified corrective power change. The input from the mobile device 60 can be based on an input to the mobile device 60 from a user or from a medical professional. In some instances, the input from the mobile device 60 can be based on an operation/property of the mobile device 60. In other instances, the mobile device 60 can act as an intermediary between a sensor (not shown) and the controller 20, in a similar manner as discussed in more detail with respect to FIG. 9.

Referring now to FIG. 9, illustrated is a system 7 that includes a controller 20 within the body 10 of the ophthalmic device and one or more sensor(s) 72 and 74. The controller 20 can include a processor 22 and a non-transitory memory 24. The one or more sensor(s) 72 can sense and/or record at least one parameter related to a condition of a patient's eye, an environment of the patient, or the like. In some instances, at least a portion of the controller 20 can be outside the ophthalmic device and in wireless communication with the other portion(s). The controller 20 can include automatic control logic that can govern operation of the system 7 in a closed loop manner. The closed loop can be based on data from the sensor(s) 72 and/or 74. Sensor(s) 72 can be included (embedded) within the ophthalmic device body 10, while sensor(s) 74 can be external to the ophthalmic device (e.g., part of a wearable and/or handheld device). The system 7 can include only internal sensor(s) 72, only external sensor(s) 74, or a combination of both. The controller 20 can receive input from one or more internal sensors 72 and/or one or more external sensors 74 by wireless and/or wired communication. The controller 20 can receive the recorded at least one parameter related to the condition of the patient's eye, the environment of the patient, or the like, and then configure the control signal based on the recorded at least one parameter related to the condition of the patient's eye, the environment of the patient, or the like, to determine whether the at least the other optical state should be triggered, a duration of the time period of the at least the other optical state, and/or which of the at least the other optical state should be triggered. The recorded at least one parameter related to the condition of the patient's eye can be at least one of a contraction of ciliary muscles, interpupillary distance, pupil diameter, gaze direction, gaze distance, user activity, and/or a time of day. The parameter related to the environment of the patient can include, for example, a measurement of the accommodation of the eye optically or electrically and/or a measurement of light intensity and/or wavelength.

For example, the internal sensors 72 can include electromyography electrodes that can measure the contraction of the ciliary muscle to automatically adjust the adaptive optics when the eye naturally accommodates. In another example, the internal sensor(s) 72 and/or the external sensor(s) 74 can include an optical sensor that can detect when a user could blink their eye(s) in a predetermined and recognizable pattern that the controller 20 can determine indicates a specific switch the adaptive optical elements 14 between near and distance states. Alternately, an external sensor 74 on a set of glasses or goggles could also be used to image the eye (using CMOS sensors, for example) and determine based on the interpupillary distance what level of accommodation is desired.

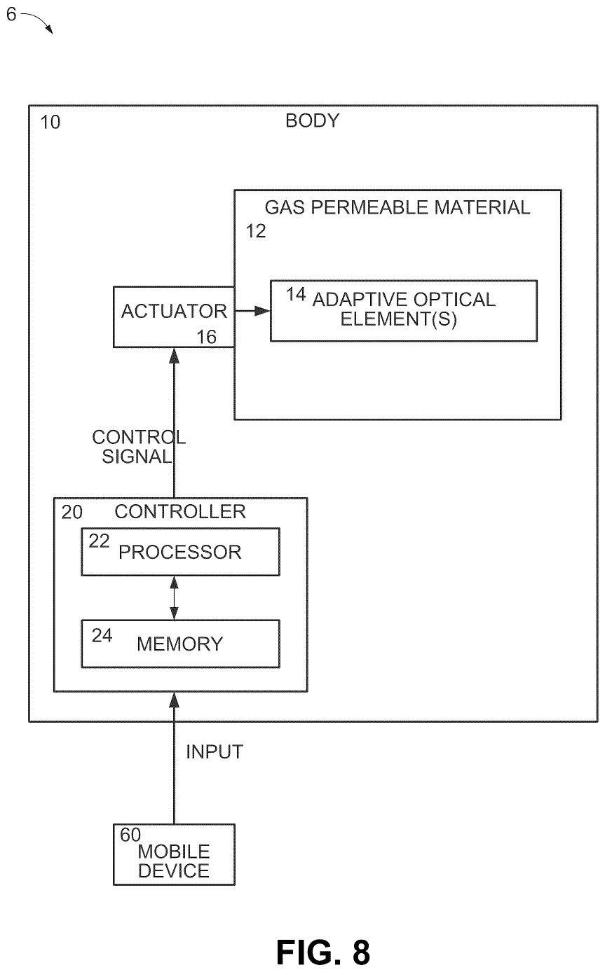

FIG. 10 is an illustration of an example automatic control loop operation using the closed loop system of FIG. 7 (which may be controlled by a controller). The controller 20 can receive one or more thresholds (or predetermined values) indicating how data from the sensor should be applied within the control loop (e.g., in the most basic case if sensor data is above a threshold (or predetermined value) make X change, if below make no change). The sensor 80 can be continuously (e.g., at predetermined time intervals such as 1 second, 10 seconds, 30 seconds, 1 minute, five minutes, or the like) sensing a variable related to the user's vision. The sensor 80 (internal or external) can be in communication with the controller 20 and can send a signal indicative of the sensed variable at the time to the controller. The controller 20 can determine a control signal to send to the actuator 16 based on the signal from the sensor 80 and the threshold(s) (or predetermined values) stored in memory. The controller 20 can, for example, use at least one of proportional, integral, or derivative control laws. For example, an accommodation set point (e.g., accommodation of the eye) can be compared by the controller 20 with a current accommodation signal (the previously sent control signal) and the controller can determine whether the adaptive optical elements 14 should be actuated by actuator 16 at the time. If the controller 20 determines a change is needed it sends the control signal to the actuator 16 that can then (based on the type of actuator used and the type of adaptive optical element(s) used) activate the desired change to the adaptive optical element(s) 14. The adjusted adaptive optical elements 14 change a corrective power of at least a portion of the ophthalmic device to “treat” the eye, which can then change the vision variable sensed by the sensor 80. A simple version of the control loop can make an ON-OF decision, but it should be understood that more advanced systems can decide beyond more than a simple ON-OF (LC optic system) and can select certain magnitudes of treatment (e.g., electro-wetting system).

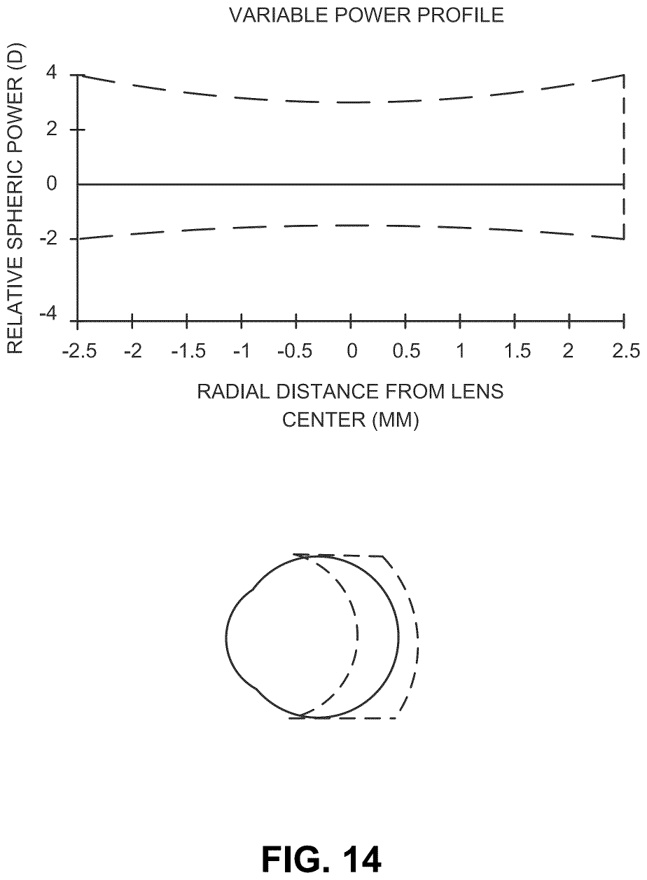

FIG. 15 shows a graphical representation of an example ON/OFF automatic control loop operation based on a sensor that can detect, for example, a squint as a signal to turn the other optical state on/off. The sensor can monitor user eye/eyelid movement and then the controller can determine the user has squinted (as opposed to a blink) based on a gesture detection algorithm. The control signal can be sent from the controller to the actuator to switch the one or more adaptive optical element between the optical state and the other optical state (on/off) when a squint is detected.

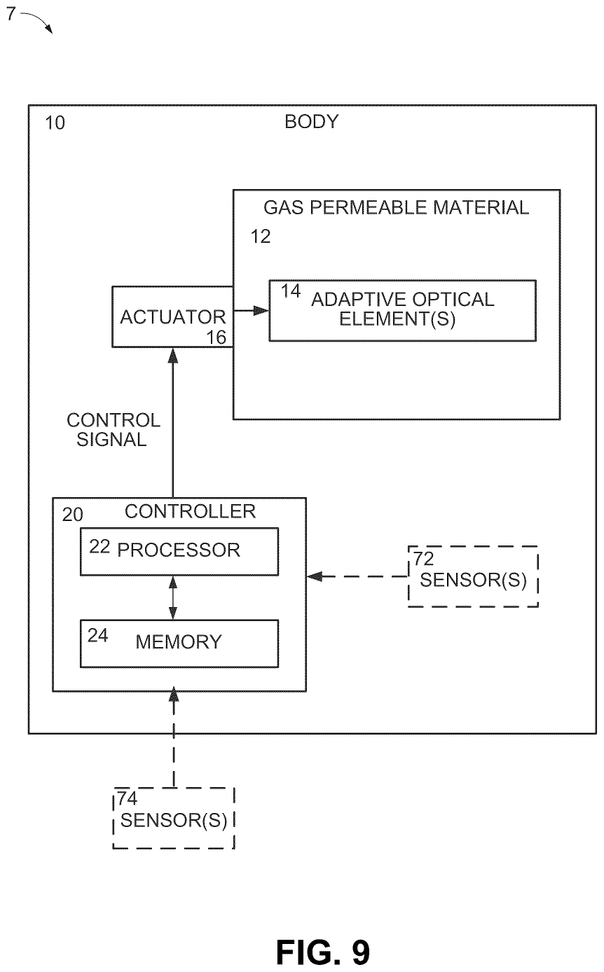

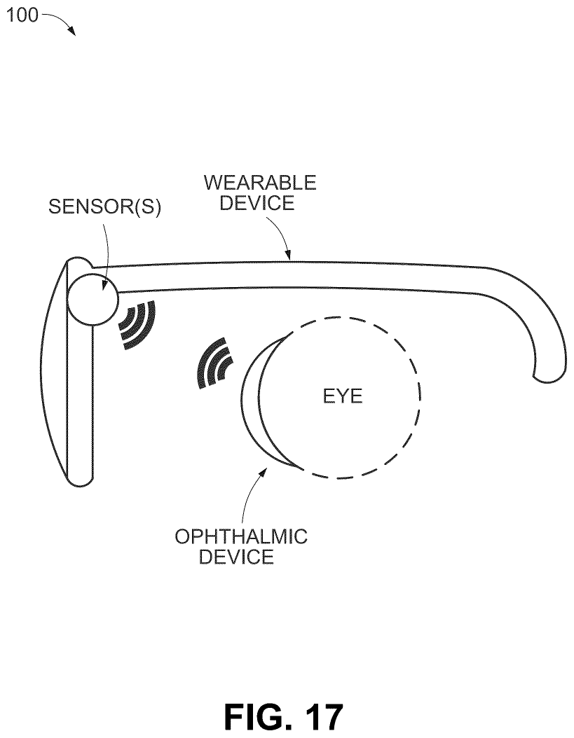

FIG. 11 is a simplified illustration of an example of the ophthalmic device of FIG. 1 as a contact lens 90 that can be positioned on a surface of the eye. The contact lens 90 shows a contact lens having an elliptical shape and a body that can fully encapsulate the components shown. The body can be entirely a gas permeable material. The electrical components (e.g., wireless transceiver, circuitry, electrodes, sensors, battery, controller, actuator, etc.) within the contact lens 90 can be arranged (e.g., attached to a ring-shaped substrate) near the edge of the contact lens in order to leave the viewing area (e.g., in the center of the lens) free of components that may obscure the line of sight. The adaptive optical elements can be purposefully positioned over the line of sight in order to affect the user's vision (e.g., based on the corrective power adjustment). The actuator can contact and/or communicate with the adaptive ocular element(s) in this example via electrode(s) that can transfer an electrical signal to activate an adjustment to adaptive optical element(s) to change a corrective power of the contact lens 90 to treat, prevent, and/or slow the progression of myopia. FIG. 17 is an illustration of an example system 100 that uses the ophthalmic device of FIG. 2 and an external sensor integrated into an external device or source. The external source can include at least one external sensor that can detect a condition of the eye or an external mobile device that can receive a manual input (e.g., from a user/patient and/or a medical professional). In the example shown in FIG. 17, the external sensor can be positioned at least partially on and/or within a wearable device (also referred to as an external device) such as glasses (illustrated), goggles (not illustrated), or the like. The ophthalmic device can be placed on the eye (e.g., can be a contact lens positioned on a surface of the eye as illustrated) and can include (as described in greater detail above) one or more adaptive optical elements embedded in a gas-permeable material and adjusted by an electrical circuit and/or actuator in response to a control signal. The one or more adaptive optical elements can switch between an optical state and at least another optical state in response to the actuator responding to the signal from the external sensor. The one or more adaptive optical elements can switch between the optical state at a time and the at least the other optical state at another time for a time period to present visual stimuli to a peripheral retina to slow axial growth of the eye. At least the external sensor of the wearable device can be in communication (e.g., wireless communication), with at least a controller (and/or processor and/or memory) associated with the ophthalmic device to relay data from the sensor as part of an automatic control loop for the dynamic adjustment of the one or more adaptive optical elements. The control signal can be pre-programmed and/or controlled and communicated from an external device based on at least one sensor reading. For instance, the control signal can establish a pre-programmed duty cycle, aimed at delivering a certain dose of positive refractive power, targeting most impactful times of the patient's eyes' circadian rhythm, and/or minimizing interference with daily activities (see e.g., FIG. 16).

As another example, the wearable device can include at least one sensor that can track and/or detect one or more variables related to a wearer's vision. The wearable device (via the at least one sensor) can track one or more variables that include, but are not limited to, interpupillary distance, pupil diameter, light intensity, light wavelength, time of day/year, gaze direction, user activity (e.g., reading, driving, etc.), screen time, or the like. The wearable device can wirelessly communicate a control signal to the actuator of the ophthalmic device (in some instances, through the controller) to dynamically adjust the one or more adaptive optical elements, based on a change in the one or more variables, such as light intensity, light wavelength, time of day, time of year, and/or a user activity. For example, the wearable device can send an input to the actuator to adjust the one or more adaptive optical elements to change the corrective power of at least a portion of the ophthalmic device (e.g., in a user controlled, preprogrammed, or automatic manner) in response to a change in the variable. It should be noted that the system including the wearable device with the at least one sensor and the ophthalmic device can also receive and control adjustment of the one or more adaptive optical elements based on at least one manual input from a user. For example, the manual input can take the form on a predetermined pattern of blinks and/or squints associated with a given change to the one or more adaptive optical elements (see e.g., FIG. 15). Additionally, while not shown the external device may be a handheld device rather than a wearable device and the user and/or a medical professional can enter a manual input communicated (wirelessly) to the ophthalmic device, wherein the manual input can include at least one of: a request to adjust the one or more adaptive optical elements at a time, a schedule for adjusting the one or more adaptive optical elements, or a change to a degree of the adjustment of the one or more adaptive optical elements.

### IV. Methods

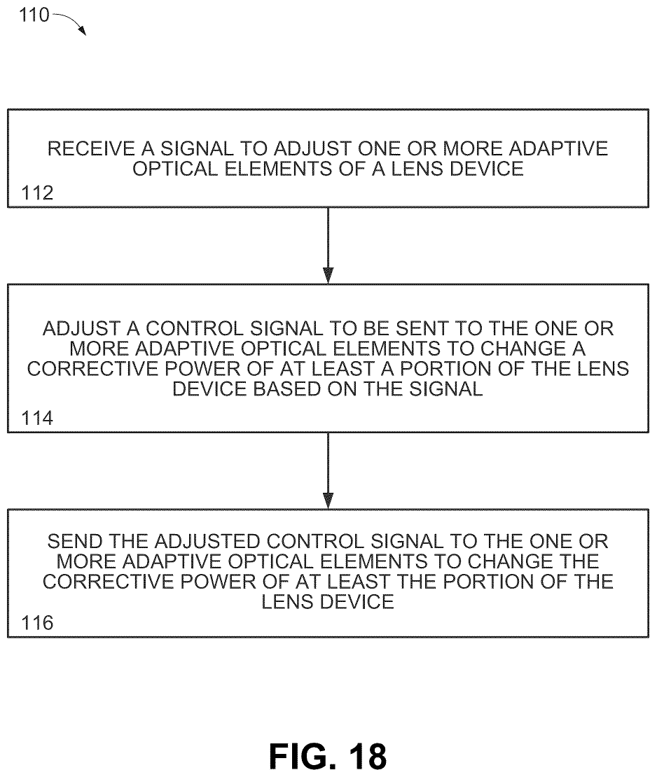

Another aspect of the present disclosure can include an example method 110 (shown in FIG. 18) for controlling and slowing the progression of myopia by changing the corrective power of an ophthalmic device having one or more adaptive optical elements. Examples of the ophthalmic device are shown in FIGS. 1-17. The method 110 is illustrated as process flow diagrams with flowchart illustrations that can be implemented by/with the devices and systems shown above.

For purposes of simplicity, the method 110 is shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the method 110. It should be noted that one or more steps of the method 110 can be executed by a hardware processor.

At 112, a processor associated with the ophthalmic device can receive a signal to adjust one or more adaptive optical elements of the ophthalmic device. The ophthalmic device can include at least a body that includes (or is substantially made of) a gas permeable membrane, the one or more adaptive optical elements embedded in the gas permeable membrane, and an actuator in communication with the one or more adaptive optical elements. The ophthalmic device can entirely encapsulate the processor (e.g., as part of a microcontroller or the like). The ophthalmic device can also include wireless transmission elements (for receiving and/or sending data). The signal received by the processor can be related to manual or automatic control of the one or more adaptive optical elements. The signal can be sent from a memory associated with the processor and can be a part of a prescheduled therapy regimen (e.g., at 9 am the signal includes instructions to change to X corrective power, at 9 pm the signal includes instructions to change to Y corrective power). In another example, the signal can be sent from an external device such as a mobile device (e.g., including an application related to control of the ophthalmic device) in response to a manual user input to change the one or more adaptive optical elements a certain way (e.g., manual change to a specified corrective power or manual change based on if the user is planning to work on a near or far vision task or at a computer).

In another example, the signal can be sent from a sensor that can be in communication with the processor. The sensor can be included in the ophthalmic device or the sensor can be external to the ophthalmic device (e.g., integrated in a wearable device). The sensor can sense a variable related to the vision of the patient, a condition of the eye of the patient, and/or an environment of the patient. The signal from the sensor can be indicative of a variable related to the vision of the user of the ophthalmic device as sensed by the sensor at a given time. The variable related to the vision of the user of the ophthalmic device, the condition of the eye of the user of the ophthalmic device, and/or an environment of the user of the ophthalmic device can include, but is not limited to, a pattern of blinks and/or squints, change in a pupil dilation, contraction of the ciliary muscles, light intensity, light wavelength, or the like. The sensor can be, for example, an optical sensor, a pressure sensor, a voltage sensor, or the like.

The signal can be sent to the processor and the control signal can be determined based on the variable related to the vision of the user of the ophthalmic device. At 114, the processor can adjust the control signal (e.g., based on contents of the signal as described above) to be sent to the one or more adaptive optical elements to change a corrective power of at least a portion of the ophthalmic device based on the signal, for example by switching optical states. As an example, when the variable includes a pattern of blinks and/or squints, the control signal can be adjusted based on the pattern of blinks and/or squints being matched with one of a plurality of predetermined patterns. The plurality of predetermined patterns can be stored in a memory associated with the processor and can each indicate a different desired change in the one or more adaptive optical elements be performed. As another example, the variable related to the vision of the user of the ophthalmic device can include contraction of the ciliary muscles of the eye of the user of the ophthalmic device at a time, and the control signal can be based on a degree of contraction of the ciliary muscles. For instance, the sensor can detect when the patient is not focusing their eye(s) and can signal the system to increase the corrective power while the eye(s) remains unfocused (e.g., can be ended when the eye is sensed to refocus). A database relating the degree of contraction of the ciliary muscles with the amount of change in the one or more adaptive optical elements and/or corrective power can be stored in a memory associated with the controller.

The adjusting the control signal in response to the signal (e.g., when the signal is from a sensor) can include applying at least one of a proportional, integral, or derivative control law, such that the signal received is compared with at least one predetermined threshold or predetermined value (e.g., data stored in the memory) to determine if the control signal should be adjusted at that time. As another example, the adjustment of control signal can be based on a pre-programmed schedule for changing the corrective power of the at least the portion of the ophthalmic device.

At 116 the processor can send the adjusted control signal to the one or more adaptive optical elements to the electrical circuit and/or actuator to cause the one or more of the plurality of the adaptive optical elements to switch between the optical state at a time and the at least the other optical state at another time for a time period to present visual stimuli to a peripheral retina to slow axial growth of the eye. The control signal can make the actuator actuate the one or more adaptive optical elements the required amount based on the received signal. The action of the actuator can depend on the type of actuator and/or the type of adaptive optical elements used in the ophthalmic device. The actuator can be, for example, an electrical circuit, at least a part of which can be included in the body of the ophthalmic device. In some instances, the entire electrical circuit can be included in the ophthalmic device (e.g., within the gas permeable membrane) with at least a portion contacting the one or more adaptive optical elements (e.g., a voltage source, circuitry, and one or more electrodes). The electric circuit can provide a voltage (e.g., above a threshold voltage, also referred to as a predetermined value) to the one or more adaptive optical elements to cause a change related to the one or more adaptive optical elements.

The one or more adaptive optical elements can be any of the configurations described above. For example, the one or more adaptive optical elements can be formed in one or more zones that can provide a uniform change in corrective power and/or a variable change in corrective power when the optical state is switched for the at least the other optical state. For, instance the one or more adaptive optical elements can include at least two zones of adaptive optical elements positioned within different portions of the body and the at least two zones can change differently in response to the electrical signal. The one or more adaptive optical elements can be any material that can change between optical power and/or refractory states in response to actuation. As an example, the one or more adaptive optical elements can be liquid crystal elements, and the actuator can provide a voltage greater than a threshold (ore predetermined value) to electrodes on the liquid crystal elements to change a crystal state and, accordingly, the refractive state of the liquid crystal elements. An ophthalmic device with an electrically activated liquid crystal switchable diffractive lens may be active in only one polarization of incident light. In this active case, the liquid crystal switchable diffractive lens switches between a monofocal state where the user will have the best central vision, and a therapeutic multifocal state where the two orthogonal polarizations are focused at different planes in the eye. By implementing a switching between states, the ophthalmic device is able to deliver a larger multifocal range than a user would be happy to tolerate under all conditions.

As another example, the one or more adaptive optical elements can include the boundary between two immiscible liquids with different refractive indices, and the electrical circuit can deliver a voltage greater than a threshold (or predetermined value) that dictates a fluid boundary curvature via electrowetting. Beyond these examples, it should be understood that the one or more adaptive optical elements can include, but are not limited to, electrochromic materials, liquid crystal materials, pH sensitive materials, a boundary between two immiscible fluid elements with different refractive indices, or thermodynamic materials. Additionally, the actuator can also be a mechanical, hydraulic, pneumatic, or magnetic actuator configured to initiate a change in the one or more adaptive optical elements in response to a control signal from the processor.

From the above description, those skilled in the art will perceive improvements, changes and modifications. Such improvements, changes and modifications are within the skill of one in the art and are intended to be covered by the appended claims.

What is claimed is:

1. A lens device configured to be placed on a patient's eye for treating and/or preventing myopia, the lens device comprises:
a body comprising a gas-permeable material;
one or more adaptive optical elements embedded in the gas-permeable material and each of the one or more adaptive optical elements configured to switch between an optical state and at least another optical state; and
an electrical circuit and/or actuator configured to cause one or more adaptive optical elements to switch between the optical state and the at least the other optical state based on a control signal,
wherein the one or more adaptive optical elements switch between the optical state at a time and the at least the other optical state at another time for a time period to present visual stimuli to a peripheral retina to slow axial growth of the eye.

2. The lens device of claim 1, wherein the visual stimuli comprises a transformation of a visual scene, wherein the transformation preserves at least 10% contrast at a spatial frequency of at least 1 cycle/degree.

3. The lens device of claim 1, wherein the optical slate has a corrective power and an associated focal plane and/or length and the at least one other optical state has another corrective power and associated focal plane and/or length.

4. The lens device of claim 1, wherein the one or more adaptive optical elements comprise at least two zones of adaptive optical elements positioned within different portions of the body,
wherein in the optical state of the at least two zones of the one or more adaptive optical elements have a same corrective power and an associated focal plane and/or length and in the at least the other optical state the at least two zones have different corrective powers and associated focal lengths and/or planes.

5. The lens device of claim 4, wherein the at least two zones comprise at least a central zone and a peripheral zone,
wherein the central zone and the peripheral zone in the optical state have a same corrective power and an associated focal length and/or focal plane, and
wherein the central zone and the peripheral zone in the at least the other optical state each have the different corrective power and the associated focal lengths and/or focal planes.

6. The lens device of claim 1, wherein the one or more adaptive optical elements comprises one adaptive optical element that affects one polarization of an incident light, wherein the optical state has a corrective power that is common for all polarizations of the incident light and the at least the other optical state has another corrective power that is different between orthogonal polarizations of the incident light.

7. The lens device of claim 1, wherein the one or more adaptive optical elements are one or more liquid crystal elements and/or one or more immiscible fluid elements with different refractive indices.

8. The lens device of claim 1, further comprising one or more sensors configured to sense and/or record at least one parameter related to a condition of the patient's eye.

9. The lens device of claim 8, further comprising a controller configured to receive the recorded at least one parameter related to the condition of the patient's eye and configure the control signal based on the recorded at least one parameter related to the condition of the patient's eye to determine whether the at least the other optical state should be triggered, a duration of the time period of the at least the other optical state, and/or which of the at least the other optical state should be triggered.

10. The lens device of claim 8, wherein the recorded at least one parameter related to the condition of the patient's eye is a contraction of ciliary muscles, interpupillary distance, pupil diameter, gaze direction, gaze distance, user activity, and/or a time of day.

11. The lens device of claim 8, wherein at least one sensor is configured to measure accommodation of the eye optically or electrically and/or to measure light intensity and wavelength.

12. The lens device of claim 1, wherein the optical state has a corrective power to focus visual stimuli relative to the peripheral retina and the at least the other optical state has a greater corrective power to focus visual stimuli at a shorter distance relative to the peripheral retina.

13. A system for treating and/or preventing myopia, the system comprising:
a lens device configured to be placed on a patient's eye for treating and/or preventing myopia, the lens device comprises:
a body comprising a gas-permeable material;
one or more adaptive optical elements embedded in the gas-permeable material and each of one or more adaptive optical elements configured to switch between an optical state and at least another optical state; and
an electrical circuit and/or actuator configured to cause one or more adaptive optical elements to switch between the optical state and the at least the other optical state based on a control signal,
wherein the one or more adaptive optical elements switch between the optical state at a time and the at least the other optical state at another time for a time period to present visual stimuli to a peripheral retina to slow axial growth of the eye,
an external source configured to deliver an input signal to an electrical circuit and/or the actuator, wherein the external source comprises:
at least one sensor detecting a condition of the eye, and/or
an external mobile device receiving a manual input from the patient and/or a medical professional.

14. The system of claim 13, wherein the control signal is pre-programmed and/or user controlled and communicated from an external device.

15. The system of claim 13, wherein the control signal establishes a pre-programmed duty cycle, aimed at delivering a certain dose of positive refractive power, targeting most impactful times of the patient's eyes' circadian rhythm, and/or minimizing interference with daily activities.

16. The system of claim 13, wherein the external source comprises a pair of eyeglass frames comprising the at least one sensor, wherein the at least one sensor is configured to detect interpupillary distance, pupil diameter, gaze direction, gaze distance, user activity, and/or a time of day.

17. A method for treating and/or preventing myopia, the method comprising:
receiving, by a processor associated with a lens device configured to be worn on a patient's eye, a signal to adjust one or more adaptive optical elements of the lens device, wherein the lens device comprises:
a body comprising a gas-permeable material,
one or more adaptive optical elements embedded in the gas-permeable material and each of the one or more adaptive optical elements configured to switch between an optical state and at least another optical state, and
an electrical circuit and/or actuator configured to cause one or more adaptive optical elements to switch between the optical state and the at least the other optical state based on a control signal;
adjusting, by the processor, the control signal to cause the one or more adaptive optical elements to change a corrective power of at least a portion of the lens device; and
sending, by the processor, the adjusted control signal to the electrical circuit and/or actuator to cause the one or more of the plurality of the adaptive optical elements to switch between the optical state at a time and the at least the other optical state at another time for a time period to present visual stimuli to a peripheral retina to slow axial growth of the eye.

18. The method of claim 17, further comprising sensing, by at least one sensor in communication with the processor, a variable related to vision of the patient, wherein a signal indicative of the variable related to the vision of the patient is sent to the processor and the control signal is determined based on the variable related to the vision of the patient.

19. The method of claim 17, wherein the control signal is adjusted based on a pre-programmed schedule for changing the corrective power of the at least the portion of the lens device.

20. The method of claim 17, wherein the one or more adaptive optical elements comprise at least two zones of adaptive optical elements positioned within different portions of the body and the at least two zones are configured to change differently in response to the electrical signal.
